(19) United States
(12) Patent Application Publication
(10) Pub. No.: US 2019/0213921 A1
(43) Pub. Date: Jul. 11, 2019

(54) POP-UP CARD WITH A REMOVABLE NOTECARD

(71) Applicants: Robin S.K. Rose, Cambridge, MA (US); Max N. Freiert, Salem, MA (US); Emilio Latorre Armendariz, Arlington, MA (US); Elana N. Walker, Somerville, MA (US); Dariush S. Nejad, Somerville, MA (US); Mansi Monhani, Jamaica Plain, MA (US)

(72) Inventors: Robin S.K. Rose, Cambridge, MA (US); Max N. Freiert, Salem, MA (US); Emilio Latorre Armendariz, Arlington, MA (US); Elana N. Walker, Somerville, MA (US); Dariush S. Nejad, Somerville, MA (US); Mansi Monhani, Jamaica Plain, MA (US)

(21) Appl. No.: 16/244,553

(22) Filed: Jan. 10, 2019

Related U.S. Application Data
(60) Provisional application No. 62/615,771, filed on Jan. 10, 2018.

(51) Int. Cl. G09F 1/06; G09F 1/10

(52) U.S. Cl. CPC G09F 1/06; G09F 1/08; G09F 1/10

(57) ABSTRACT

A pop-up card includes a notecard that can be inserted into and removed from a pocket formed between the cover of the card and a panel secured to and overlaying at least a portion of the cover.

### CROSS REFERENCE TO RELATED APPLICATION

This application claims priority from U.S. Provisional Patent Application No. 62/615,771 filed on Jan. 10, 2018 entitled POP-UP CARD WITH INTEGRATED POCKET FOR HOLDING NOTECARDS AND OTHER ITEMS, which is hereby incorporated by reference.

### BACKGROUND

The present application relates generally to pop-up cards and, more particularly, to pop-up cards having an integrated pocket for holding notecards and other items.

Pop-up cards are greeting-type cards that include an erectable pop-up display structure that unfolds from a flattened state when the card is closed to a 3-D state when the card is opened. FIG. 1 shows one example of a prior art pop-up card 100 that includes a rose bouquet pop-up display structure 102 on a foldable card 104.

U.S. Pat. No. 9,524,658, which is incorporated by reference herein in its entirety, illustrates some examples of how such pop-up display structures can be constructed from intersecting slice-form elements and attached to foldable cards. FIG. 2 taken from that patent shows a portion of an exemplary pop-up display structure, which comprises intersecting slice-form elements 106, 108. The slice-form elements 106, 108 include tabs 110, 112, respectively, at their bases. As shown in FIG. 3, the pop-up display structure is attached to the card by inserting and securing the tabs 110, 112 in slots 114 formed in a panel 116 overlaying the card cover.

The pop-up card can also be configured so that the pop-up display structure is secured in, but removable from the rest of the card when desired by a user.

### BRIEF SUMMARY OF THE DISCLOSURE

In accordance with one or more embodiments, a pop-up card with a removable notecard is disclosed. The pop-up card includes (a) a cover having an interior face and an opposite exterior face, the cover being foldable along a crease line defining a first section of the cover on one side of the crease line and a second section of the cover on the opposite side of the crease line, the cover being foldable and unfoldable along the crease line between a closed position wherein the first section of the interior face of the cover faces the second section of the interior face of the cover and an opened position wherein the first section of the interior face of the cover and the second section of the interior face of the cover are separated; (b) a panel secured to and overlaying at least a portion of the second section of the cover, wherein the panel and the second section of the cover define a pocket therebetween; and (c) an erectable pop-up display structure comprising a plurality of intersecting slice-form elements on the interior face of the cover such that when the cover is in the closed position, the pop-up display structure is in a flattened state, and wherein when the cover is in the opened position, the pop-up display structure is in an erected 3-D state. The notecard is removably inserted in the pocket between the panel and the second section of the cover.

In accordance with one or more embodiments, a method of using a pop-up card with a removable notecard is disclosed. The method comprises opening the pop-up card by unfolding a cover of the card from a closed position to an opened position thereby automatically causing an erectable pop-up display structure in the pop-up card to move from a flattened state to an erected 3-D state; removing a notecard from a pocket in the pop-up card formed between the cover and a panel secured to and overlaying at least a portion of the cover; and performing a given action on the notecard (such as, e.g., viewing the notecard or writing or drawing on the notecard).

In accordance with one or more embodiments, a pop-up card with a removable notecard is disclosed. The notecard including a tab at one end thereof. The pop-up card comprises (a) a cover having an interior face and an opposite exterior face, the cover being foldable along a crease line defining a first section of the cover on one side of the crease line and a second section of the cover on the opposite side of the crease line, the cover being foldable and unfoldable along the crease line between a closed position wherein the first section of the interior face of the cover faces the second section of the interior face of the cover and an opened position wherein the first section of the interior face of the cover and the second section of the interior face of the cover are separated; (b) a first panel secured to and overlaying at least a portion of the first section of the interior face of the cover; (c) a second panel secured to and overlaying at least a portion of the second section of the interior face of the cover, wherein the second panel and the second section of the cover define a pocket therebetween for receiving and holding the notecard, wherein the tab is visible when the notecard is in the pocket to improve detection of the notecard and to facilitate removal of the notecard from the pocket; and (d) an erectable pop-up display structure comprising a plurality of intersecting slice-form elements on the first and second panels such that when the cover is in the closed position, the pop-up display structure is in a flattened state, and wherein when the cover is in the opened position, the pop-up display structure is in an erected 3-D state.

### BRIEF DESCRIPTION OF THE DRAWINGS

FIG. 1 is a perspective view of a prior art pop-up card.

FIGS. 2 and 3 are perspective views of a pop-up display structure attached to card in accordance with the prior art.

FIG. 4 is a perspective view of a pop-up card in accordance with one or more embodiments.

FIG. 5 is an enlarged view of a portion of FIG. 4.

FIG. 6 is a top view of the pop-up card in accordance with one or more embodiments.

FIG. 7 is a bottom view of the pop-up card in accordance with one or more embodiments.

FIG. 8 is an exploded view of the pop-up card in accordance with one or more embodiments.

FIG. 9 is an exploded view of an alternate pop-up card in accordance with one or more embodiments.

FIGS. 10-19 are top views of exemplary notecards in accordance with one or more embodiments.

FIG. 20 illustrates a pop-up card having a panel overlaying an exterior surface of the card cover in accordance with one or more embodiments.

Like or identical reference numbers are used to identify common or similar elements.

### DETAILED DESCRIPTION

Various embodiments disclosed herein relate to pop-up cards having an integrated pocket for holding notecards. The notecard can contain a personalized message or other information for the recipient of the pop-up card.

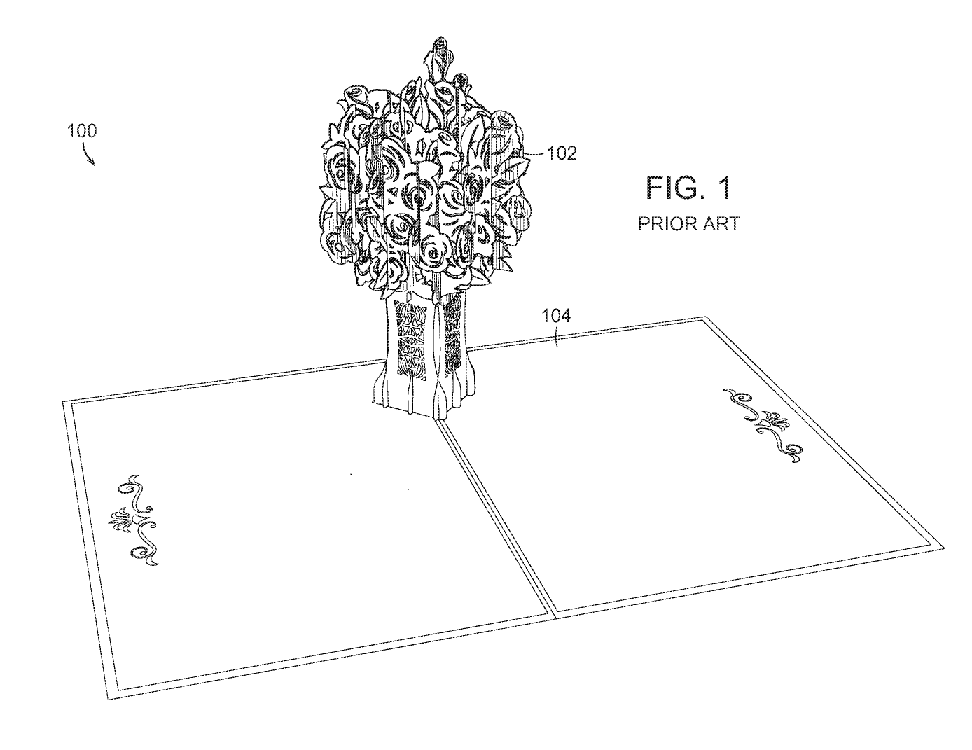

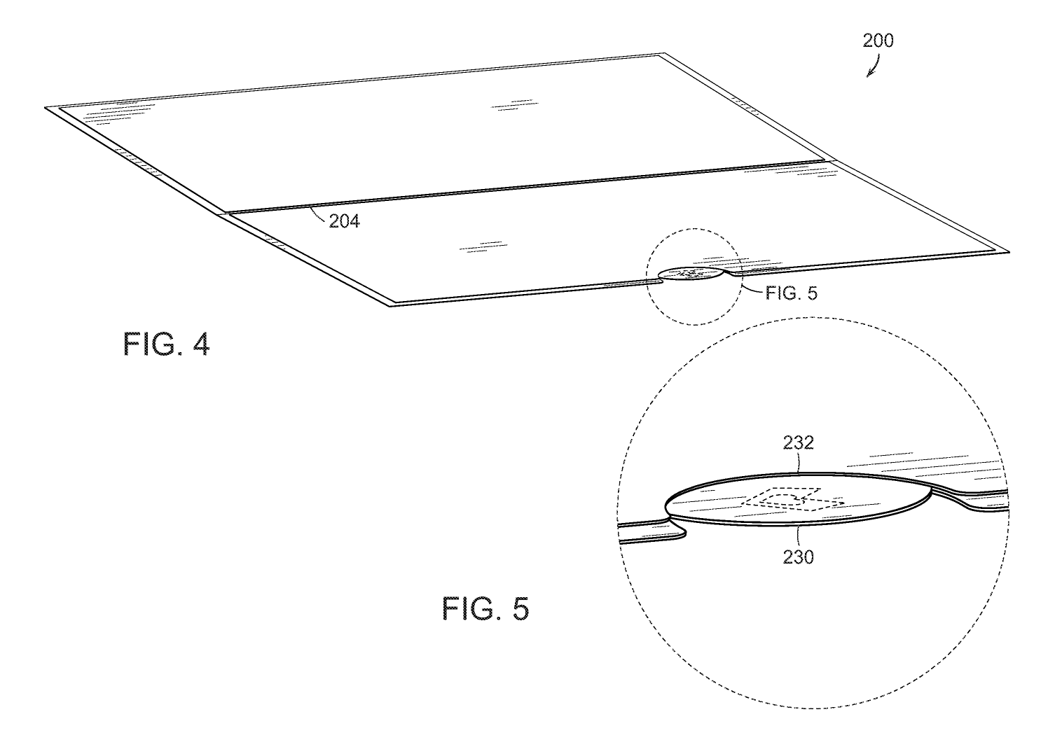

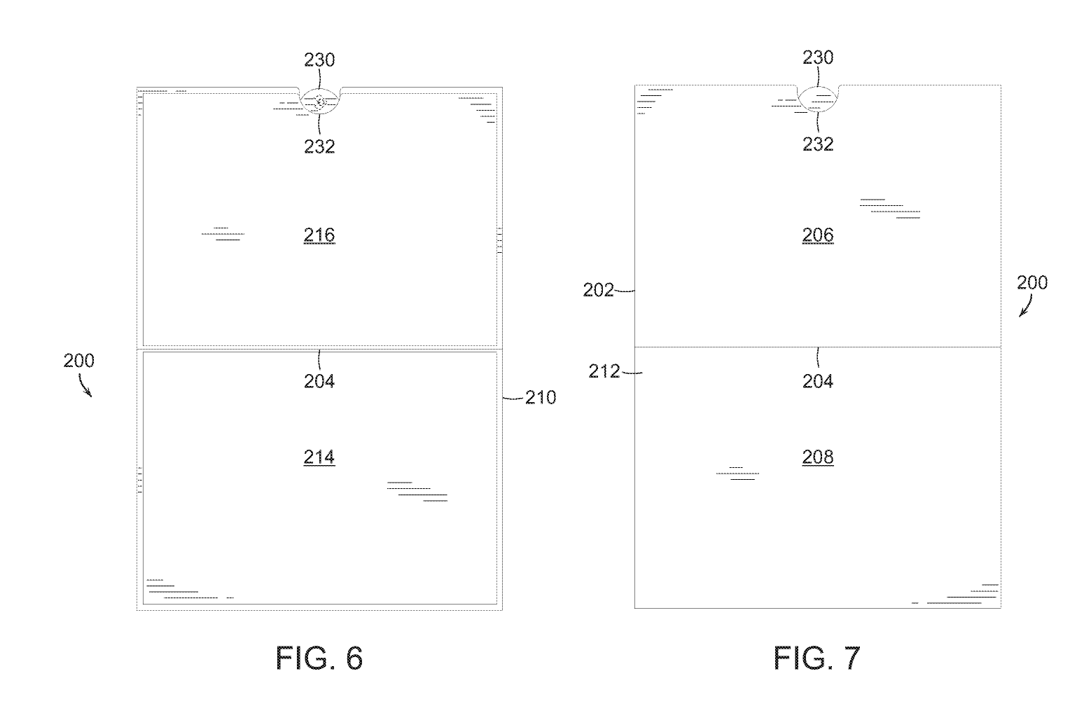

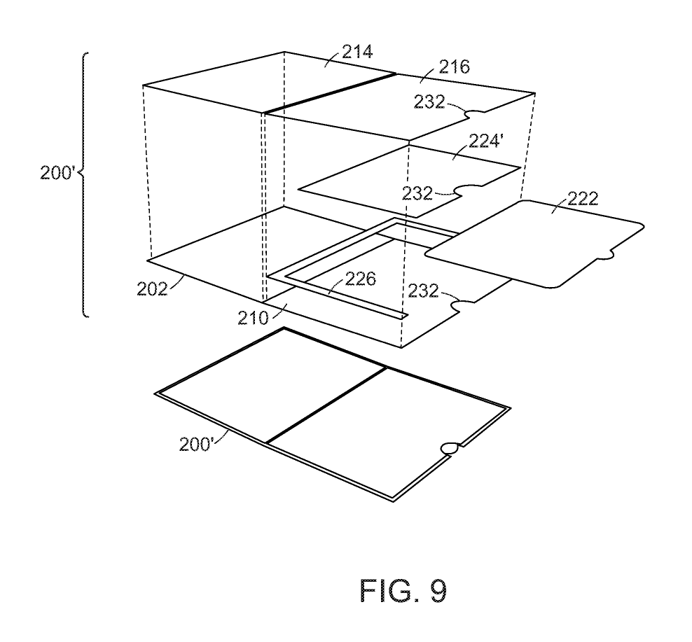

FIGS. 4-8 illustrate one example of a pop-up card 200 with an integrated pocket for holding a removable notecard in accordance with one or more embodiments. FIG. 9 shows an exemplary alternative construction of the pop-up card. In each of these figures, the pop-up display structure has been omitted so that the integrated pocket feature can be more easily illustrated. It should be understood that a pop-up structure is intended to be part of the illustrated cards, e.g., in a similar way the pop-up structure in FIGS. 1-3 is included in the card. The pop-up structure can also be removably provided in the card. The pop-up display structure comprises a plurality of intersecting slice-form elements. When the card is in a closed position, the pop-up display structure is in a flattened state, and when the card is in an opened position, the pop-up display structure is in an erected 3-D state.

The pop-up card 200 includes a cover 202 that is foldable along a crease line 204. The cover 202 has an interior face 210 (outer edges of which are shown in FIG. 3) and an opposite exterior face 212 (shown in FIG. 4). The crease line 204 defines a right cover section 206 (forming a back cover) on one side of the crease line 204 and a left cover section 208 (forming a front cover) on the opposite side of the crease line 204. The cover 202 can be folded and unfolded along the crease line 204 between a closed position and an opened position.

A left panel 214 overlays and is secured to the left cover section 208 on the interior face 210 of the cover. A right panel 216 is secured to and overlays the right cover section 206 on the interior face 210 of the cover. The right panel 216 and the right cover section 206 define a pocket therebetween for receiving a notecard 222. The notecard 222 can be slid into and out of the pocket when desired. The pocket is preferably configured such that the notecard 222 slides easily into and out of the pocket when desired, but is held tightly enough to inhibit it from inadvertently slipping out.

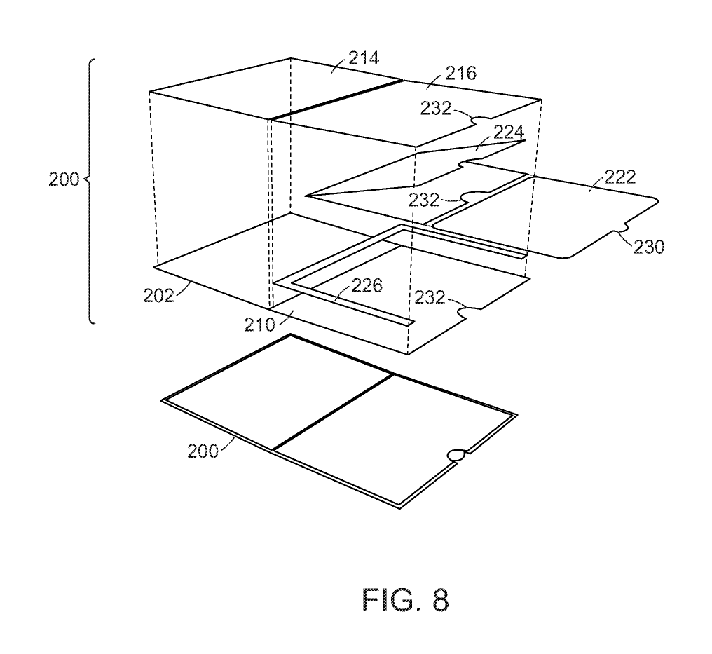

In one or more further embodiments, a sleeve 224 is provided in the pocket to hold the notecard 222 as illustrated in FIG. 8. The sleeve 224 is positioned within the pocket between the right panel 216 and the cover 202. In the illustrated embodiment, the sleeve 224 comprises a thin envelope style folded piece. The sleeve 224 provides glide surfaces to ease insertion and removal of the notecard 222 from the pocket.

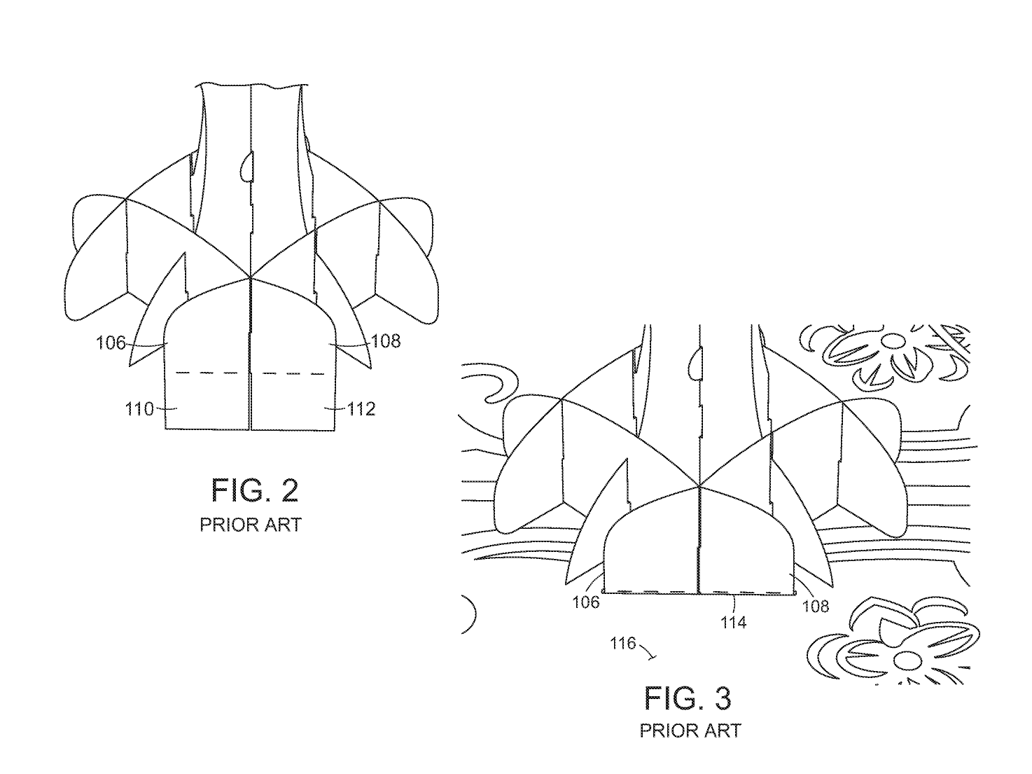

The sleeve 224 protects the notecard 222 from getting caught on the tabs (e.g., 110, 112 in FIG. 2) in the pop-up sculpture that connect the pop-up sculpture to the right panel 216. The sleeve 224 also prevents (or at least inhibits) the notecard 222 from getting caught on any die-cut components of the back cover 202 (e.g., the back cover may include a logo or other information die-cut in the cover). In addition, the fold in the sleeve 224 prevents (or at least inhibits) the notecard sliding too far into the card.

The size and shape of the sleeve 224 can be varied to accommodate different notecard shapes.

The pop-up card 200 also includes a frame structure 226 also secured between the right panel 216 and the cover 202 around three sides of the sleeve 224. The frame structure 226 acts as a spacer to separate the back cover 202 from the right panel 216 in order to provide sufficient space in between layers for the rest of the parts to exist and the notecard 222 to readily slide in and out. It also secures the right panel 216 and the cover 202 to each other.

The sides of the frame structure 226 also function as guiderails for the notecard 222 as it is slid in and out of the sleeve 224. The frame structure 226 also functions as a backstop, preventing over-insertion of the notecard 222 in the pocket.

The size and shape of the frame structure 226 can be varied to accommodate different notecard shapes.

In one or more embodiments, the frame structure 226 can include visual identifiers that allow the assemblers of the pop-up card 200 to place the rest of the parts in their correct places.

In the illustrated embodiments, the notecard 222 has a generally rectangular shape with rounded corners. The notecard 222 may also have square corners. In addition, it may comprise various non-rectangular shapes.

The notecard 222 includes a tab 230 projecting from one side thereof that can be grasped by a user to enable the notecard 222 to be easily removed from the pocket. The back cover 202, the right panel 216, and the sleeve 224 each include a notch 232 therein configured to expose the notecard tab 230 and to enable the user to more easily grasp the tab 230.

The tab 230 and the notches 232 in the card 200 also serve the function of visually indicating the presence of the notecard 222 to a new user who may not have prior knowledge that there is a notecard 222 in the pop-up card 200.

In one or more embodiments, the notecard tab 230 can be marked with visual elements, e.g., product branding marks. In one or more embodiments, physical elements may be provided on the notecard tab 230 in addition to or instead of the visual elements. Non-limiting examples of such physical elements can include embossed elements, Braille text, or a ribbon to assist a user in pulling out the notecard 222.

In the illustrated embodiments, the tab 230 is semicircular in shape. It should be noted that the size, shape, and location of the tab can be varied.

In accordance with one or more embodiments, the notecard 222 can be configured to hold another physical item such as, e.g., a gift card or a piece of jewelry. As shown in FIG. 19, the notecard 222′ includes slits 240 on its face for retaining a gift card or other item in place.

FIG. 9 is an exploded view of an alternate pop-up card 200′, which is similar to the card 200, but includes a different sleeve 224′. The sleeve 224′ comprises a flat non-folded piece secured to the underside of the right panel 216.

In the embodiments illustrated in the figures herein, the pop-up card 200 includes a single notecard on the right side of the card. In other embodiments that are not shown, the notecard may be on the left side of the card. Alternatively, two notecards could be provided: one on the right side of the card and one on the left side of the card.

In one or more alternate embodiments, instead of two panels 214, 216, the pop-up card includes a single panel that covers one or both sides of the cover.

In one or more alternate embodiments, the two panels 214, 216 (or a single panel) overlay and are attached to the exterior side of the cover to define one or more pockets between the exterior side of the cover and the one or more panels for holding the removable notecard.

The following are non-limiting examples illustrating some possible ways in which the notecard of the pop-up card may be used.

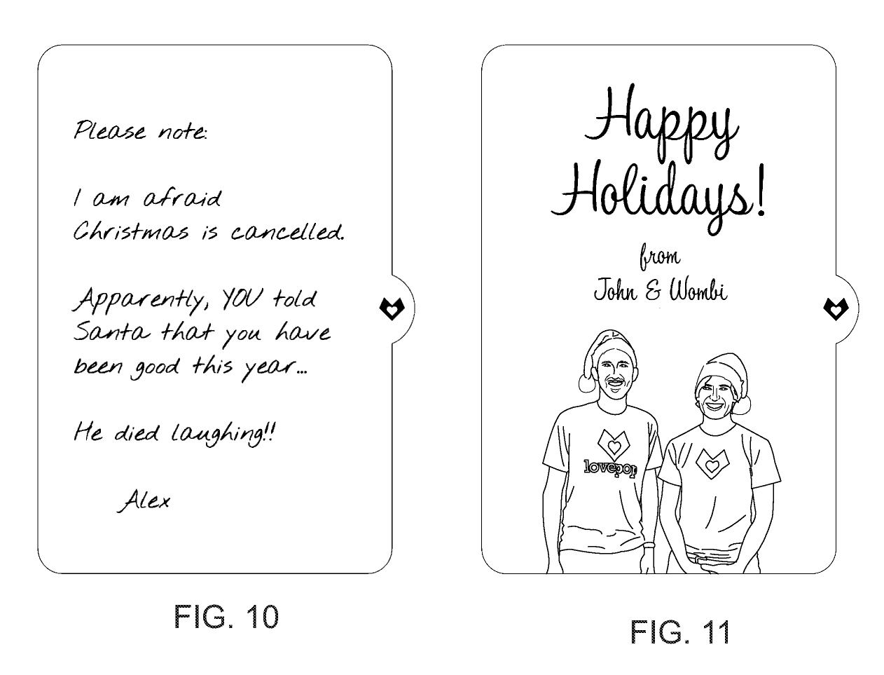

As shown in FIG. 10, a user may write or draw on the notecard using a hand writing/drawing instrument like a pen or pencil. A user may print a message on the notecard using a printer.

As shown in FIG. 11, a user may print a photograph and message on the notecard using a printer.

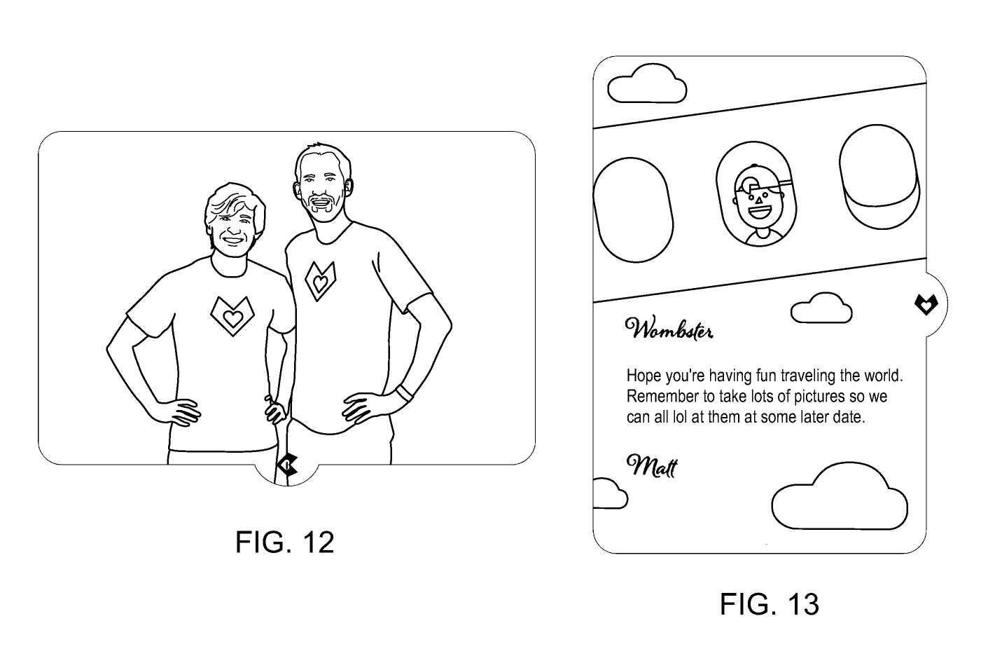

As shown in FIG. 12, a user may print a full bleed photograph on the notecard utilizing the full area of the notecard.

Notecards can include a full color template. The notecard can have a printed pre-determined and user-chosen template as background that covers the whole surface of the notecard. A message can be printed or handwritten on top of the printed template as shown, e.g., in FIG. 13.

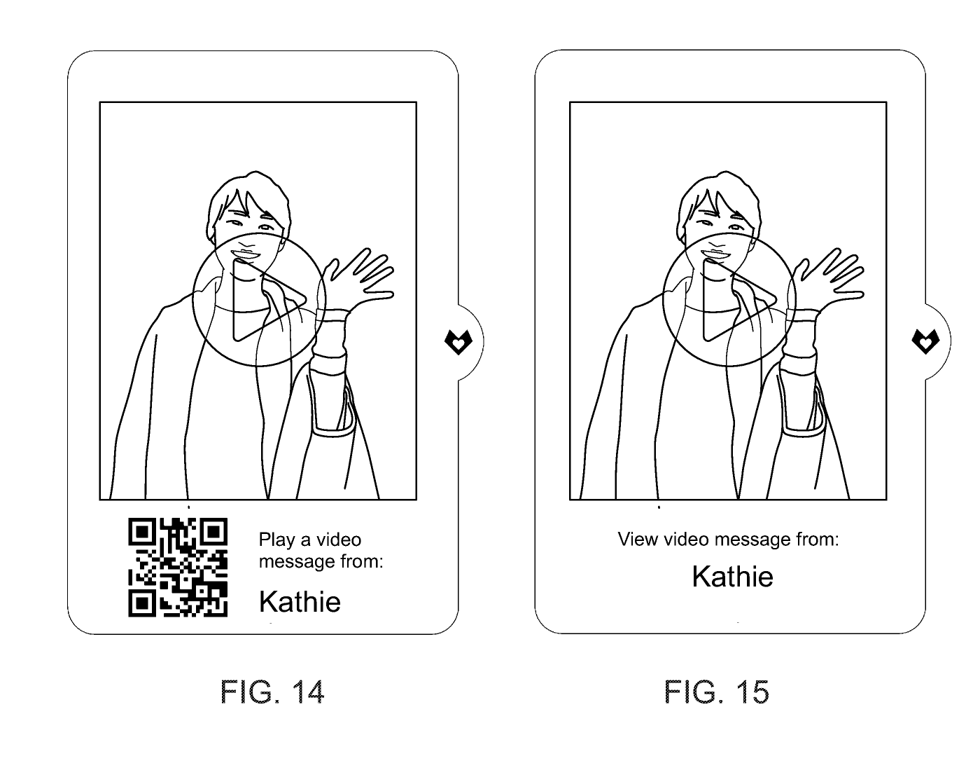

A notecard can include a QR (or other computer-readable) code that the user can read with any QR reading capable device (e.g., a smartphone) for various purposes including, e.g., to access pre-recorded media personalized for the user as shown in FIG. 14 or other information.

A notecard can have augmented reality (AR) capabilities that allows access to pre-recorded media personalized to the user by detecting the notecard's visual profile and the printed material inside the notecard as shown in FIG. 15.

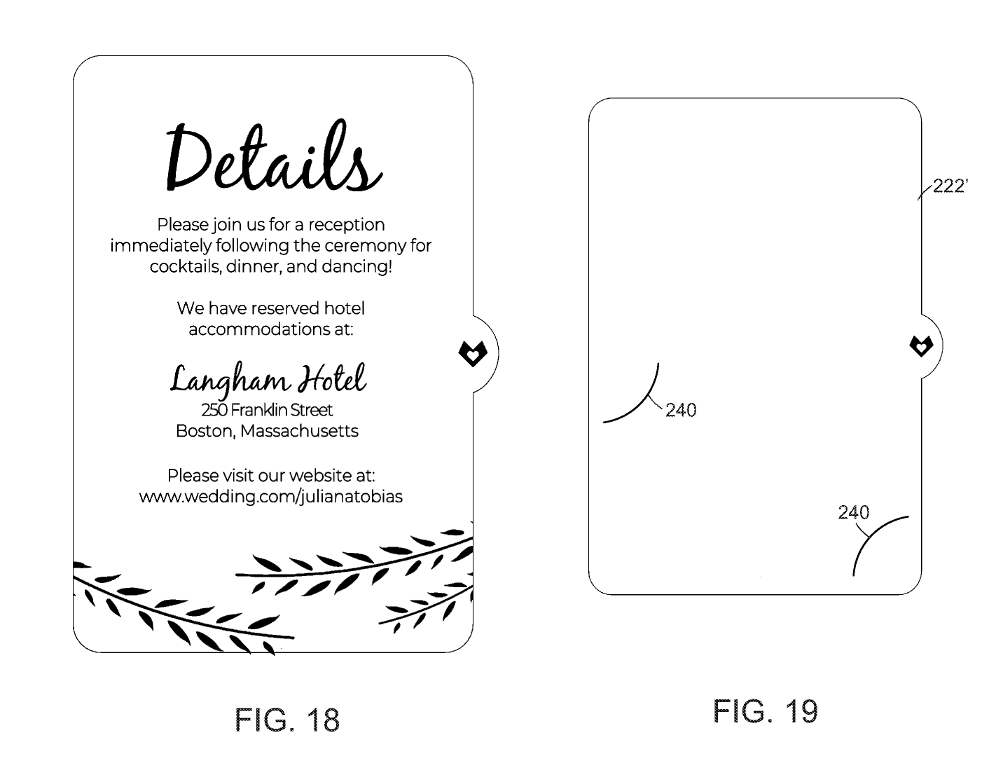

Notecards can be used as a Wedding/Event information card with embellishment and content. A notecard can be the information card for wedding invitations printed in a notecard as shown in FIG. 18. Such notecards can have customizable themes such as different embellishment designs, different positions of embellishments, a full theme template/photograph printed as a background, and customizable text to be written/printed.

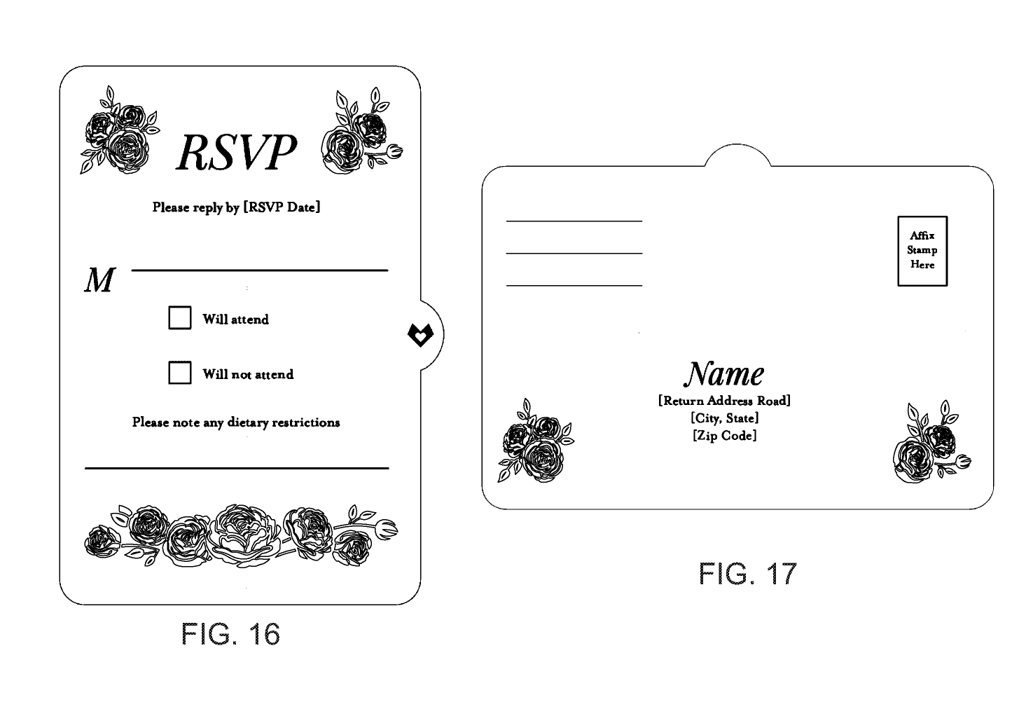

The notecard can be a wedding RSVP card as shown, e.g., in FIG. 16. The notecard can have a customizable return address on the back of the notecard as shown, e.g., in FIG. 17. The notecards can have customizable themes including different embellishment designs, different positions of embellishments, full theme template/photograph printed as a background, customizable text to be written/printed.

Notecards can also be used for branding/merchandising. For example, a physical wallet-sized gift card can be attached to the notecard as shown in FIG. 19. The notecard can include a printable code that can be used as an in-store credit to an online store. The notecard can be a branded, full bleed card in the styling of a gift card from the company issuing the gift card. In addition, the notecard can be a bi-fold notecard that can be used as a pull out brochure.

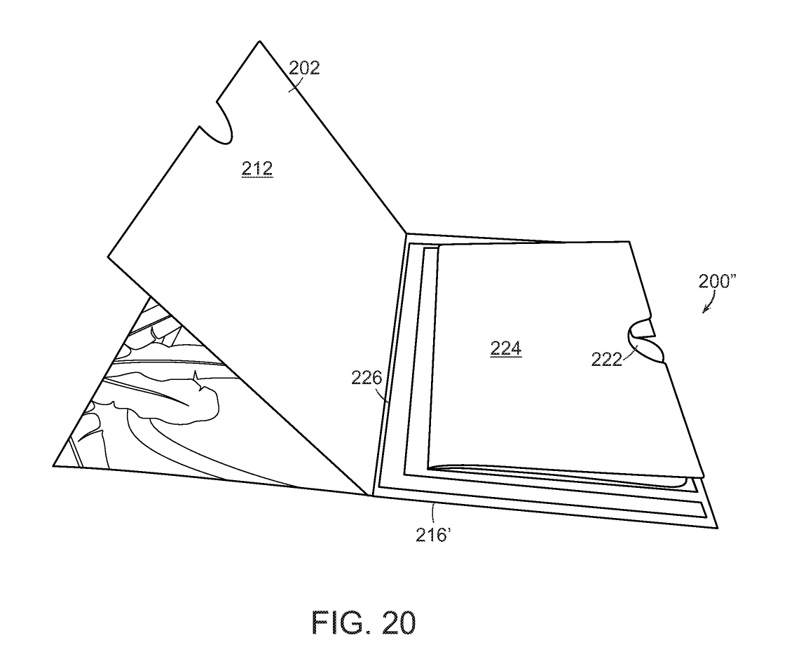

In embodiments such as the FIG. 8 pop-up card 200, a right panel 216 is secured to and overlays the right cover section 206 on the interior face 210 of the cover 202 to define a pocket there-between for receiving a notecard 222. FIG. 20 illustrates an alternative embodiment 200″ in which the pocket for holding the notecard 222 is formed by the card cover 202 and a panel 216′ overlaying the exterior face 212 of the card cover 202. In FIG. 20, the panel 216′ is shown unattached to the card cover 202 for purposes of illustration. The panel 216′ is glued or otherwise attached to the card cover 202.

A sleeve 224 (like the sleeve 224 of FIG. 8) is provided in the pocket to receive the notecard 222. A frame structure 226 (like the frame structure 226 of FIG. 8) is secured between the panel 216′ and the cover 202 around three sides of the sleeve 224.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

1. A pop-up card with a removable notecard, comprising:
a pop-up card comprising
(a) a cover having an interior face and an opposite exterior face, said cover being foldable along a crease line defining a first section of the cover on one side of the crease line and a second section of the cover on the opposite side of the crease line, said cover being foldable and unfoldable along the crease line between a closed position wherein the first section of the interior face of the cover faces the second section of the interior face of the cover and an opened position wherein the first section of the interior face of the cover and the second section of the interior face of the cover are separated;
(b) a panel secured to and overlaying at least a portion of the second section of the cover, wherein the panel and the second section of the cover define a pocket therebetween; and
(c) an erectable pop-up display structure comprising a plurality of intersecting slice-form elements on the interior face of the cover such that when the cover is in the closed position, the pop-up display structure is in a flattened state, and wherein when the cover is in the opened position, the pop-up display structure is in an erected 3-D state; and
a notecard removably inserted in the pocket between the panel and the second section of the cover.

2. The pop-up card of claim 1, further comprising a sleeve positioned within the pocket, said sleeve providing one or more glide surfaces for the notecard to ease insertion and removal of the notecard from the pocket.

3. The pop-up card of claim 2, further comprising a frame structure secured between the panel and the second section of the cover around three sides of the sleeve forming guiderails and a backstop for the notecard in the pocket.

4. The pop-up card of claim 1, further comprising a frame structure secured between the panel and the second section of the cover around three sides of the notecard, said frame structure forming guiderails and a backstop for the notecard in the pocket.

5. The pop-up card of claim 1, wherein the notecard includes a tab at one end thereof projecting from the pocket to improve detection of the notecard and to facilitate removal of the notecard from the pocket.

6. The pop-up card of claim 1, wherein the tab is semicircular in shape.

7. The pop-up card of claim 1, wherein the tab includes physical and/or printed markings thereon.

8. The pop-up card of claim 1, wherein the panel and the second section of the cover each include a notch exposing a portion of the notecard in the pocket to improve detection of the notecard and to facilitate removal of the notecard from the pocket.

9. The pop-up card of claim 1, wherein the notecard includes a tab at one end thereof projecting from the pocket, and wherein the panel and the second section of the cover each include a notch about the tab on the notecard to improve detection of the notecard and to facilitate removal of the notecard from the pocket.

10. The pop-up card of claim 1, wherein the panel is on the right side of the pop-up card.

11. The pop-up card of claim 1, wherein the panel is on the left side of the pop-up card.

12. The pop-up card of claim 1, wherein the cover and the panel comprise card stock.

13. The pop-up card of claim 1, wherein the panel includes one or more slots, and wherein the pop-up display structure includes one or more tabs at the base thereof, said one or more tabs being inserted into and retained in said one or more slots.

14. The pop-up card of claim 1, wherein the notecard has rounded corners or square corners.

15. The pop-up card of claim 1, wherein the notecard includes one or more slits for receiving and holding an item.

16. The pop-up card of claim 15, wherein the item comprises a gift card or a gift item.

17. The pop-up card of claim 1, wherein the panel is secured to and overlays the second section of the interior face of the cover.

18. The pop-up card of claim 1, wherein the panel is secured to and overlays the second section of the exterior face of the cover.

19. The pop-up card of claim 1, wherein the panel is secured to and overlays at least a portion of the first section and at least a portion of the second section of the cover.

20. The pop-up card of claim 1, further comprising an additional panel secured to and overlaying at least a portion of the first section of the cover.

21. The pop-up card of claim 20, wherein the panel is secured to and overlays the second section of the interior face of the cover, and the additional panel is secured to and overlays the first section of the interior face of the cover.

22. A method of using a pop-up card with a removable notecard, comprising:
opening the pop-up card by unfolding a cover of the card from a closed position to an opened position thereby automatically causing an erectable pop-up display structure in the pop-up card to move from a flattened state to an erected 3-D state;
removing a notecard from a pocket in the pop-up card formed between the cover and a panel secured to and overlaying at least a portion of the cover; and
performing a given action on the notecard.

23. The method of claim 22, wherein the given action comprises viewing an image or text on the notecard or writing or drawing on the notecard.

24. The method of claim 22, further comprising returning the notecard to the pocket and closing the pop-up card.

25. A pop-up card with a removable notecard, comprising:
a notecard including a tab at one end thereof; and
a pop-up card comprising
(a) a cover having an interior face and an opposite exterior face, said cover being foldable along a crease line defining a first section of the cover on one side of the crease line and a second section of the cover on the opposite side of the crease line, said cover being foldable and unfoldable along the crease line between a closed position wherein the first section of the interior face of the cover faces the second section of the interior face of the cover and an opened position wherein the first section of the interior face of the cover and the second section of the interior face of the cover are separated;
(b) a first panel secured to and overlaying at least a portion of the first section of the interior face of the cover;
(c) a second panel secured to and overlaying at least a portion of the second section of the interior face of the cover, wherein the second panel and the second section of the cover define a pocket therebetween for receiving and holding the notecard, wherein the tab is visible when the notecard is in the pocket to improve detection of the notecard and to facilitate removal of the notecard from the pocket; and
(d) an erectable pop-up display structure comprising a plurality of intersecting slice-form elements on the first and second panels such that when the cover is in the closed position, the pop-up display structure is in a flattened state, and wherein when the cover is in the opened position, the pop-up display structure is in an erected 3-D state.

26. The pop-up card of claim 25, further comprising a sleeve positioned within the pocket, said sleeve providing one or more glide surfaces for the notecard to ease insertion and removal of the notecard from the pocket.

27. The pop-up card of claim 26, further comprising a frame structure secured between the second panel and the second section of the cover around three sides of the sleeve forming guiderails and a backstop for the notecard in the pocket.

28. The pop-up card of claim 25, wherein the second panel and the second section of the cover each include a notch exposing a portion of the notecard in the pocket to improve detection of the notecard and to facilitate removal of the notecard from the pocket.

29. The pop-up card of claim 25, wherein the notecard includes one or more slits for receiving and holding an item.
